(19) United States
(12) Patent Application Publication
(10) Pub. No.: US 2004/0133906 A1
(43) Pub. Date: Jul. 8, 2004

(54) Device for selecting channel of radio and television sets and method for selecting channel of radio and television sets

(75) Inventor: Piotr Przybylek, Zielona Gora (PL)

Correspondence Address: HOFFMANN & BARON, LLP, 6900 JERICHO TURNPIKE, SYOSSET, NY, 11791, US

(73) Assignees: Advanced Digital Broadcast Polska Sp. z o.o; Advanced Digital Broadcast Ltd.

(21) Appl. No.: 10/669,511

(22) Filed: Sep. 24, 2003

(30) Foreign Application Priority Data
Sep. 25, 2002 (PL) P-356280

(51) Int. Cl. H04N 5/445; G06F 13/00; G06F 3/00; H04H 9/00; H04N 7/16

(52) U.S. Cl. 725/9; 725/14; 725/46

(57) ABSTRACT

A device for selecting a channel of radio and television sets includes a signal receiving block (103) used to receive the signal (102) and if necessary converting it to a digital format, an A/V block (107) generating the signal to be displayed on the screen in a required format, a memory block (106) containing various types of memory, a central processing unit (105) controlling the functionality of the receiver and a power-on block (111) with a “Power-on” function used for switching-on a set. Channels viewed by the user for a time longer than a defined time interval are stored in the database. This database may be in the form of a list containing information about consecutively selected channels. It can also have the form of tables storing information about the viewing ratings of channels viewed at a given time. The statistics obtained from this database are used to set the appropriate channel upon switching-on the set. The set channel is the one viewed most recently on a day at a time when the set is switched on.

### CROSS-REFERENCE TO RELATED APPLICATIONS

This application claims priority to Polish Application No. P-356280, filed Sep. 25, 2002, the contents of which are incorporated herein by reference.

### BACKGROUND OF THE INVENTION

1. Field of the Invention

The present invention relates to a device for selecting a channel of radio and television sets and a method for selecting a channel of radio and television sets, and especially an automatic method of setting a channel the user viewed most recently, or views most often.

2. Brief Description of the Background of the Invention Including Prior Art

The currently used and familiar television receivers are switched on by a remote control unit usually in one of two ways: by pressing a button corresponding to the number of the channel desired by the user, or by pressing the “Power-on” button, which causes the receiver to switch on and select the most recently viewed channel.

The U.S. Pat. No. 5,438,377 teaches a typical means of setting a channel while switching the television receiver on. A typical channel selector used in television receivers, video recorders etc. employs a keypad with keys corresponding to integers 0 through 9. The selector also includes a microcomputer operating in response to the keypad output. It controls the on-screen display circuit—a tuning voltage generator. A desired channel defined by a given number is easily selected by said microcomputer operated by an integral program. The user may thus operate the channel selector quickly and in real time. Essentially, the channel is set by depressing the appropriate keys on a remote control unit, describing which channel is to be switched on. With a complete lack of any “intelligent” response on the part of the system, the user sets the channel manually.

The U.S. patent application Ser. No. 2002/008,789 presents a method and an apparatus allowing for monitoring programs viewed by the user. This permits to determine preferred categories of programming and channels preferred by the viewer. To facilitate viewer access to preferred programming, the display of an electronic program guide may here be configured in accordance with the monitored viewing activity to allow quick access to preferred programs. The monitored viewing may also be used to provide a lock-out feature to prevent the viewing of a specified channel or group of programs. This feature may also be used to identify Internet items of interest to the viewer. Yet another feature here is the ability for the viewer to automatically circulate through his or her favorite programs—as determined by the function monitoring his or her viewing habits. The collected data is used for purposes other than setting a channel while switching the television receiver on.

Yet another U.S. Pat. document No. 5,801,747 teaches a method for monitoring programs viewed by the user. This document describes a passive media content access system, including a remote control unit with an electronic system monitoring the date, the time, the media type (cable, or satellite, or antenna, etc.), the current channel being viewed and various other user interactions with the system. Whenever a change is made in the settings, the system immediately logs the date, channel, time, etc. for later uploading to a control station. The user may connect the system to the Internet at any time and upload the automatically logged information to the control station, which compares this information with previously known program information to allow the determination of the program the user was viewing, or listening to. The control station determines what available information to send to the user. This information can be: e-mails, websites, printed material, software offers, or other material, which might suit the user's fancy. The control station may also be used to customize the operation of the keypad, by assigning specific functions to specific keys. The data collected by the system in this patent is used to subsequently display a program guide, at the same time storing information as to the types of programs being viewed on given channels.

The U.S. Pat. No. 5,635,989, in turn, presents yet another method for monitoring programs viewed by the user, in order to create a program guide based on the collected data. This method and apparatus, search the program guide comprising the program information for a plurality of different program sources. The program information includes: the program titles, the channels on which the programs are shown, and their show times. The viewer first enters the title of the desired program. The program guide is then reviewed as to identify each occurrence of the said desired program. If the desired program is indeed contained in the program guide, the time and channel associated with each identified occurrence of the program are displayed. This method of saving and storing program viewing ratings data involves only the length of time a given program was viewed, without taking account of the times at which it was viewed.

### SUMMARY OF THE INVENTION

Purposes of the Invention

It is an object of this invention to provide a device for selecting a channel of radio and television sets allowing an easy and quick choice of a channel to be viewed.

It is another object of this invention to provide a method for selecting a channel of radio and television sets, especially an automatic method of setting a channel the user viewed most recently, or views most often.

This and other objects and advantages of the present invention will become evident from the description, which follows.

Brief Description of the Invention

The object of the present invention is a device for selecting a channel of radio and television sets, generally receivers or shortly sets, having a power-on block with a “Power-on” function, a signal receiving block, an A/V block, a central processing unit, a memory, a viewing ratings analyzer and a ratings storage block. A choice of channel while switching the receiver on is based on viewing ratings statistics stored in a table or on a list. The set channel is the one viewed most recently on a day at a time when the receiver is switched on. In case the table or list does not contain data on channel viewing ratings at a given time, the channel set is the one last viewed at a later time. If two channels have identical viewing ratings, the one viewed last will be set. In case the table or list lacks channel viewing ratings data, the channel activated is the one most often viewed at a later time. Moreover, when comparing the viewing ratings of the channel viewed most often at a given time with the one viewed at a later time, the channel with higher viewing ratings will be set. Viewing ratings statistics are created in the following combinations: for each day of the week separately, separately for workdays (Monday through Friday) and separately for weekends, finally separately for workdays and individually for Saturdays and for Sundays. In the event there is no space for the creation of a new statistics, the statistics concerning the oldest period of time are cancelled. That data is then copied into the free space of the currently oldest statistics. Statistics are created using a list, containing information about the channel, the start and stop times of viewing of the given channel. This is done as a single list in the form of a circular buffer, where the time is stated as the date and hour, and/or as separate lists for each day, containing an unlimited number of records, where the time is stated as the hour alone. In an alternative method, the statistics are created as a table, the columns of which define time intervals, the rows define the individual days, and fields define the number of the channel viewed in a given time interval on a given day.

The novel features, which are considered as characteristic for the invention, are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the accompanying drawings one of the possible embodiments of the present invention is shown where

FIG. 1 is a schematic of a television receiver;

FIGS. 2A and 2B show a flow chart of an algorithm for monitoring viewed channels and composing viewing ratings tables;

FIGS. 3A, 3B, and 3C show a flow chart of an algorithm for monitoring viewed channels and composing a viewing ratings list;

FIGS. 4A, 4B, and 4C show a flow chart of an algorithm for setting channels based on a viewing ratings table; and

FIGS. 5A, 5B, 5C show a flow chart of an algorithm for setting channels based on a viewing ratings list.

### DESCRIPTION OF INVENTION AND PREFERRED EMBODIMENT

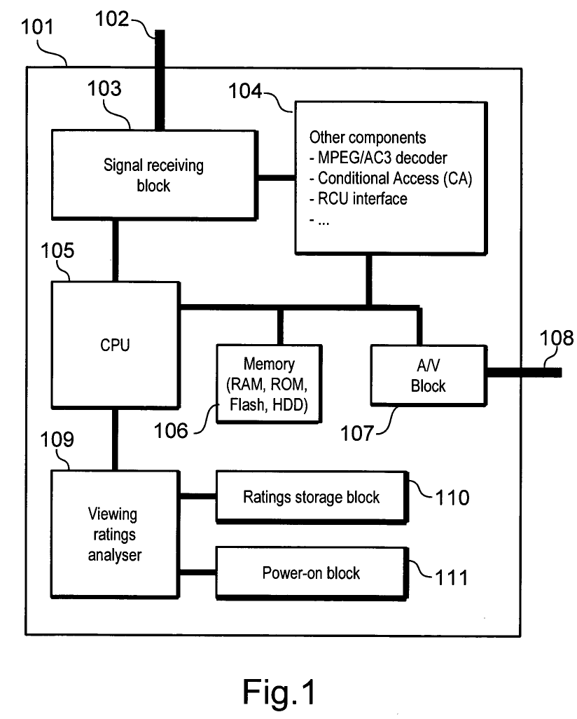

FIG. 1 shows the components of a television receiver 101, relevant to the channel selecting method described here, which includes: a signal receiving block 103 used to receive the signal 102 and if necessary converting it to a digital format, an A/V block 107 generating the signal to be displayed on the screen in a given format (RGB, PAL, NTCS etc.), a memory block 106 containing various types of memory (RAM, ROM, Flash, HDD etc.), a central processing unit 105, shortly a CPU, controlling the functionality of the receiver, a power-on block 111 with a “Power-on” function used for switching the television receiver on, a viewing ratings table creation block and a viewing ratings list creation block included in a ratings storage block 110, a viewing ratings analyzer 109 used for analyzing the viewing ratings table and/or the viewing ratings list, as well as other components 104 such as an MPEG format decoder (in digital television decoders), a conditional access (CA) block, a remote control unit (RCU) interface. The presented system application makes use of the CPU as well as of the memory systems to create and store channel viewing ratings databases. By communicating with the signal receiving block it can also determine which channel is to be set. The power-on block, used for switching the receiver on, the viewing ratings table creating block, the viewing ratings list creating block, as well as the viewing ratings analyzer may be included in the microprocessor, or make up separate circuits.

Channels viewed by the user for a time longer than a defined time interval are stored in the database. This database may be in the form of a list containing information about consecutively selected channels. It can also have the form of tables storing information about the viewing ratings of channels viewed at a given time. Each day a new list, or a row in a table, is created and added to the database. The statistics obtained from this database are used to set the appropriate channel upon switching the television receiver on. The numbers and sizes of the lists and tables may vary depending on the configuration of the system. The user may choose if the viewed channels are to be stored for each day of the week separately, together for workdays and separately for Saturdays and Sundays, workdays separate from weekends, or even all days together. The type of setting determines the choice of the channel to be set when the receiver is switched on the next day.

Below is a description of two methods for creating viewed channels databases. The first—called a list—requires less memory but more computing power. The second—called a table—takes up more space in memory, but its processing is faster.

The storage of information for individual days—for instance each day separately, or all days together—defines the way the tables and lists are processed. For the tables, the method of storing data will define the way of creating the tables. For the lists, it will define the way of searching through the list. Creating a list of viewed channels is the better of the two methods as far as the use of memory is concerned. A list contains the history of channel settings, and furthermore a single record contains information about the channel as well as the date and the times when the viewing of it started and stopped. It therefore tells, what channels were selected, in what order and for how long. The list does not include information about channels viewed for periods shorter than the T time interval. Subsequent information is added only when a channel is viewed for the required number of minutes T, which eliminates the useless information about channels scanned, reviewed or quickly changed.

A sample list formatted for a single day is shown below:

| Channel | Start | Stop |
|---|---|---|
| 5 | 18.20 | 19.20 |
| 7 | 19.20 | 20.30 |
| 8 | 20.35 | 21.40 |

A sample of a single list for all days is shown below:

| Channel | Start | Stop |
|---|---|---|
| 5 | 2002.06.20 18.20 | 2002.06.20 19.20 |
| 7 | 2002.06.20 19.20 | 2002.06.20 20.30 |
| 8 | 2002.06.20 20.35 | 2002.06.20 21.40 |

The above shown date and time storage format is meant to show the type of data saved. When actually implementing the system, the dates can be stored in a more compact form—such as the number of minutes or seconds elapsed since the year 2000, of using the MJDUTC format, defined by DVB (Digital Video Broadcast). As the result of filtering, gaps may occur in the information regarding which channel was being viewed at a given moment. For example, a five-minute gap between channels 7 and 8. In such a case, the channel set will always be the one closest in time. This will be the channel next on the list—if the time it started is closer to the current time than the one just concluded before, or the previous one—if the next is not yet in the database or if the time the previous was concluded is closer to the current time than the time the next one started.

Depending on system configuration settings, a single list may be created, containing the date and the times at which the viewed channel was switched on and off. Such a list functions as a circular buffer, where in case of memory overflow event, new information is stored in the place of the oldest. Separate lists for each day may also be created. Such a list contains only the times at which channel viewing was started and stopped. The date can be defined, for instance, by the name of the table.

The channel viewing ratings data may also be stored in viewing ratings tables. The tables are uniform in size and quicker to process than lists. Similarly, to a list, a table contains information about channels the user views in a specific time interval. The difference is that the table does not store the times the viewing of a given channel started and stopped. Every element in the table corresponds to a set time interval. In the case there exist multiple tables, the day to which the table refers may be defined, for example, by the name of the table.

| 0.00- | 0.10- | 0.20- | | 1.30- | 1.40- | | 23.30- | 23.40- | 23.50- |
|---|---|---|---|---|---|---|---|---|---|
| 0.10 | 0.20 | 0.30 | . . . | 1.40 | 1.50 | . . . | 23.40 | 23.50 | 0.00 |
| 1 | 1 | 1 | | 5 | 5 | | 24 | | |
| | | | | 4 | 4 | | 32 | 32 | 32 |
| 1 | 1 | 1 | | 5 | 5 | | | 24 | 24 |
| 2 | 2 | 2 | | 5 | 5 | | 24 | 24 | 24 |
| 1 | 1 | 1 | | 8 | 5 | | 24 | 24 | 24 |

The fields of the table shown above contain the number of a channel viewed in the time interval defined for the column the field is located in. The individual rows contain viewing ratings data for the particular days the table describes. In case the table refers to all days of the week, the rows will contain data about viewing ratings on the individual days. If every day of the week has its own table, the rows of each table contain viewing ratings data concerning that day throughout the consecutive weeks. Empty fields indicate that on a given day in a given time interval the television receiver was not active. The size of the table may be adjusted according to the amount of memory available or to the receiver processing power. The table shown in the example contains five rows. If there were only one row, the table would only refer to a single day. Increasing the number of rows allows for a more detailed specification of what channel is being viewed at what time. The time interval for which the viewing ratings data is monitored can also be increased or decreased. The ten-minute interval shown in the exemplary table was accepted to be optimal. The first row in the exemplary table is obviously not used in a real system. Knowing the viewing ratings measurement interval T (in the example: 10 min.) one can always calculate the number of the column defining the location of the given time interval using the following formula:

Column=((beginning of time interval h*60+beginning of time interval min)/T)+1

In the exemplary table, data concerning the time interval 1.30-1.40 is contained in a column with a number calculated as follows:

Column=((1*60+30)/10)+1=10

The viewing ratings list is created upon switching channels and/or switching off the receiver, as well as after a preset time elapses, defined as a multiple of T, to insure against a possible power loss. It could, for example, be 10*T. The list may be modified only at those moments. The viewing ratings tables are updated constantly while the television receiver is functioning. Operations on the tables and lists are performed in accordance with the following parameters: the length of time interval T, the number of rows R, and the maximum list size L.

The length of the time interval T, for which the viewing ratings data are being stored, defines how often the table is to be updated, and helps to calculate the number of the column, where the data are stored. For a list, it defines the shortest length of time a given channel needs to be viewed in order to be added to the list. The number of rows R defines the number of rows that may be included in the table. When a receiver is switched on for the first time in a given day, a new row is added to the top of the table. If the addition of this row would exceed the maximum allowed table size, the last row is deleted, and information contained therein is copied into the empty fields in the row second to the last. The maximum list size L, is defined by the number of records in the list. In case the system contains multiple lists, the maximum list size L may be defined by the following formula:

L=24*60/T,

where 24 is the number of hours, 60 is the number of minutes in an hour, and T is the length of the time interval in minutes. The maximum list size L will then be used to define the amount of memory needed to create a new list. In case when the system only contains one list, the maximum list size L may be defined by the amount of available memory, divided by the size of a single record. The maximum list size L will then be utilized when adding a new record to the list, in order to check if it will fit.

At the moment of system initiation, either a new list or a new row in a table is created.

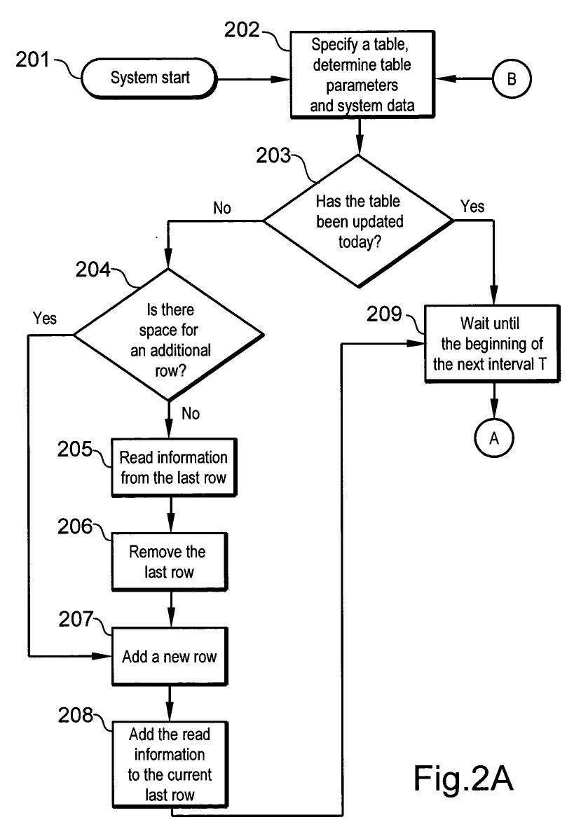

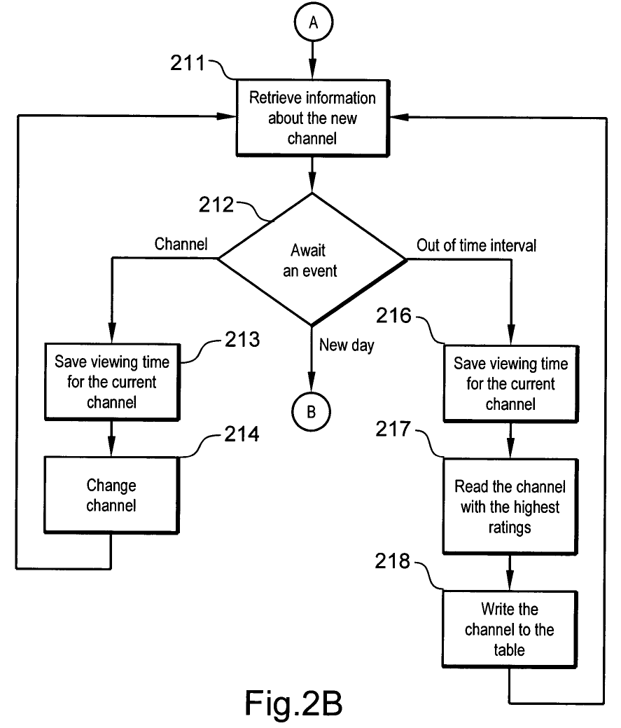

The algorithm of monitoring the viewed signal, and compiling viewing ratings tables is presented in FIGS. 2A and 2B. The procedure is started in step 201 at the moment the system is switched on—i.e. upon switching the television receiver on. In step 202, it is determined which table the system should make use of. The following step, 203, checks if the table has already been modified on that given day. If it has not, a new row is added to the table. Step 204 checks if there is enough space in the table for a new row. If there is insufficient space, information contained in the last row is stored in memory, in step 205. The last row is then deleted, in step 206. The function next adds a new row to the top of the table, in step 207. Information from the last row—in case it has been deleted—is then copied, in step 208, to the empty fields in the actual last row. In case the table contains only one row, this action will cause the new row to be filled up with information from the row describing the previous day. The procedure then moves on to monitoring the channel viewing ratings. It begins in step 209, with the start of a new time interval that is after the passing of the T time interval—for instance a full 10 minutes of a given hour. Information about what channels are being viewed is then gathered in step 211. Next, in step 212, the procedure awaits an event. When the user switches to a new channel, the procedure stores, in step 213, the time the given current channel was viewed in the auxiliary table described below, changes—in step 214—the channel to that requested by the user, and returns to step 211. When the time interval in step 212 comes to an end, the procedure stores the time the current channel was viewed in the available table, in step 216. Next, in step 217, it reads from the highest viewing ratings. It then stores this channel in the viewing ratings table, in step 218. This step concludes the procedure for the given time interval, which then returns to step 211. In case the event in step 212 turns out to be a new day (12:00 AM), the system returns to step 202, to begin the procedure of adding a new row to the table.

The auxiliary viewing ratings table contains the times the channels are being viewed in a given time interval. It looks as follows:

| Channel | Time |
|---|---|
| 1 | 5 |
| 13 | 2 |
| 3 | 1 |
| 2 | 1 |

In order to avoid problems with overfilling the table, the “Time” field may represent the minimal period of time the given channel was viewed. It can be represented as a fraction of the period T. Let us take for the given example the value of 0.1*T. It will then equal one minute and the auxiliary table will not exceed 10 rows. If a channel is viewed for less than the specified time, it will not be included in this table. This way storing information about channels the user only scanned through can be avoided.

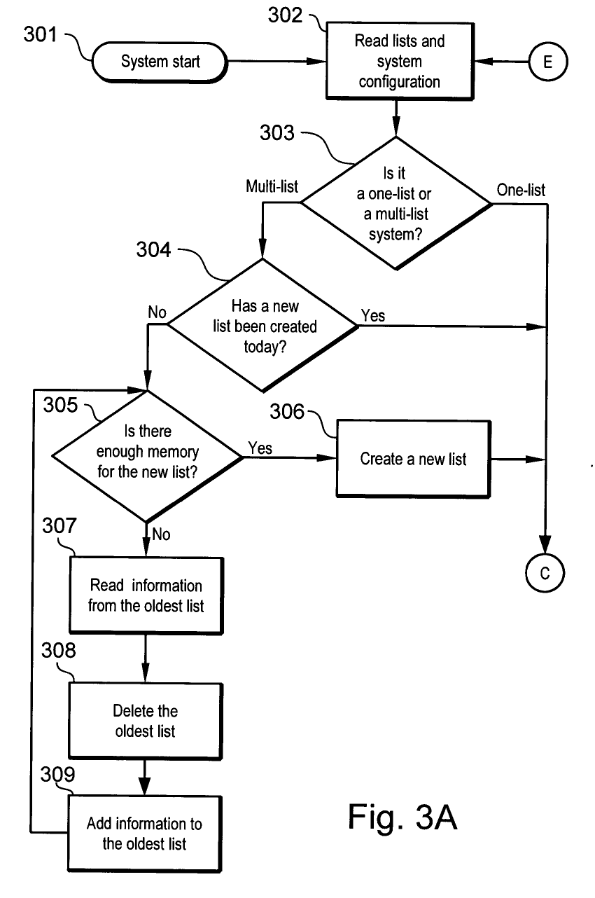

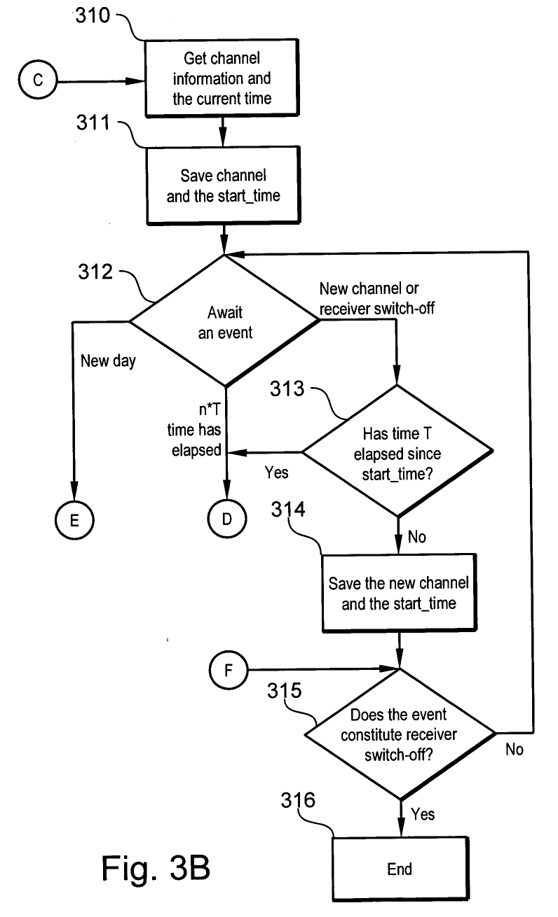

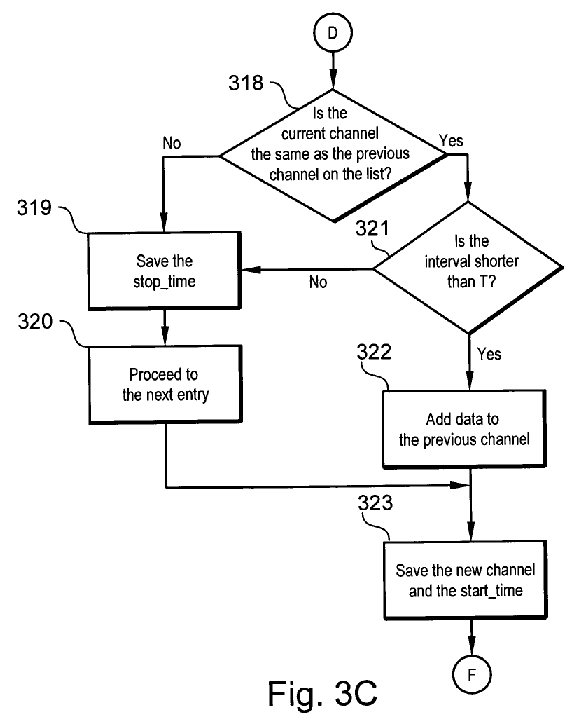

The algorithm of monitoring the viewed signal and compiling a viewing ratings list is presented in FIGS. 3A, 3B, and 3C. The procedure is started in step 301 at the moment of switching the system o—i.e. upon the television receiver is switched on. The system configuration (the number of lists used by the system, the time interval T, the maximum size of the list) is established in step 302. The following step—303—checks if the system uses a single list, or if there are separate lists for various days. If separate lists do exist, the system checks, in step 304, whether a list has already been created for the current day. If not, in step 305 it goes on to check if sufficient memory is available to create a new list (specified by the maximum list size). If there is insufficient memory the system, in step 307, reads the information contained in the oldest list. It then deletes this list in step 308. In step 309, the information read from the deleted list is added to the oldest remaining list for the same day of the week as the deleted one. The information is copied into spaces not containing any entries in the current list. The information is copied under the condition the time the given channel is viewed will be greater or equal to the time interval T. The procedure then again checks whether enough memory was released as the result of deleting the oldest list to create a new one. If so, a new list is created in step 306. The procedure then moves on to monitoring the channel viewing ratings. In step 310, it gathers information about the set channel and about the current time. In step 311, the channel and the time its viewing started at are added to the list as the last position. The system then awaits an event, in step 312. If the event happens to be the user setting a different channel, the procedure checks in step 313 whether time T has elapsed since the beginning of the last channel on the list. If it has not, in step 314 it stores the new channel and the time its viewing started at in place of the previous channel. If time T has elapsed, step 318 checks whether the currently viewed channel is the same as the one saved in the previous position on the list. If it is not, the procedure stores, in step 319, the time the viewing of the current channel was concluded. It then moves on to the next position on the list—in step 320. In case where only a single list is utilized, such list functions as a circular buffer. New elements, when such a list is full, are stored in place of the oldest. If multiple lists are utilized, moving on to a new position results in a new record being added to the list. If the channels, in step 318, turn out to be the same, step 321 checks whether the gap between the time the viewing of the previous position was concluded, and the time the viewing of the current position started is less than T. It allows for continuity in storing the viewing ratings of the given channel on the list. The time the viewing of the given channel was concluded is then—in step 322—added to the time the viewing of the given channel was concluded in the previous position on the list. Next, in step 323, the data of the newly set channel, and the time when its viewing began, are added to the current record. If the event in step 312 turns out to be switching the television receiver off, the function moves on to step 313. If that event was passing of a specified multiple of the time T, the function moves on to step 318. This is done to avoid any problems, which may arise from loss of power, when no information is added to the list. If the event was the passing of a new day (12:00 PM), the system goes back to step 302 in order to establish if a new list is to be created. The function checks, in step 315, whether the event turned out to be switching the television receiver off. If so, it is concluded in step 316. Otherwise it returns to step 312 to monitor for further events.

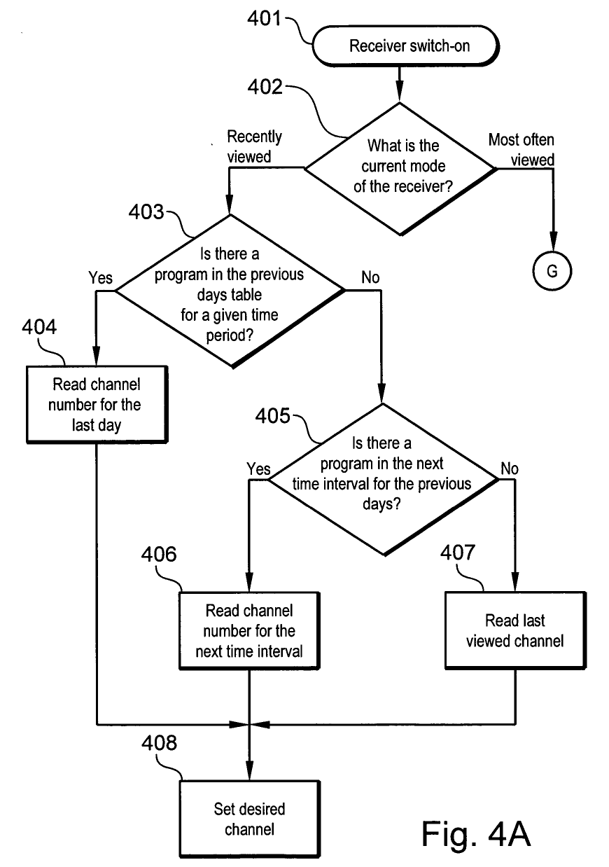

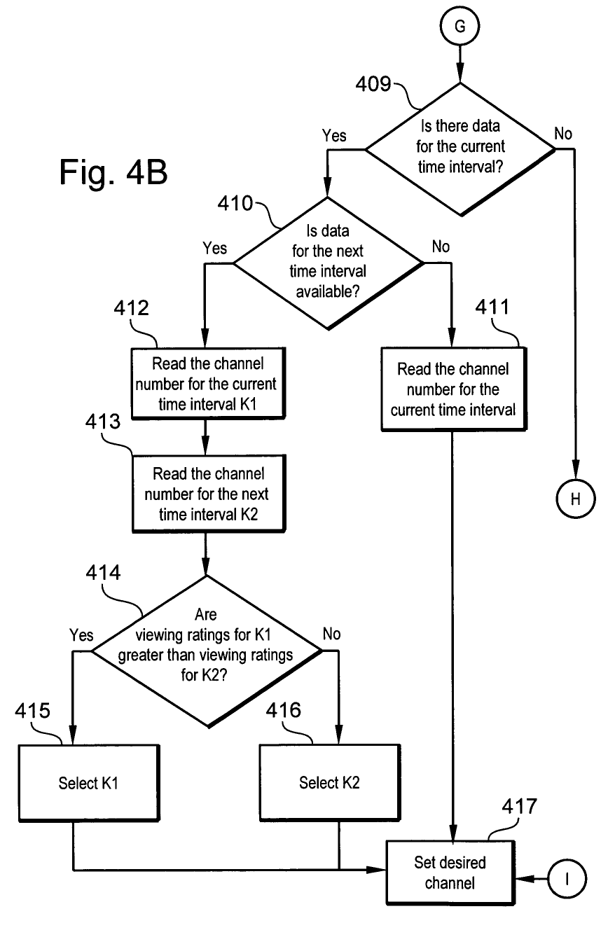

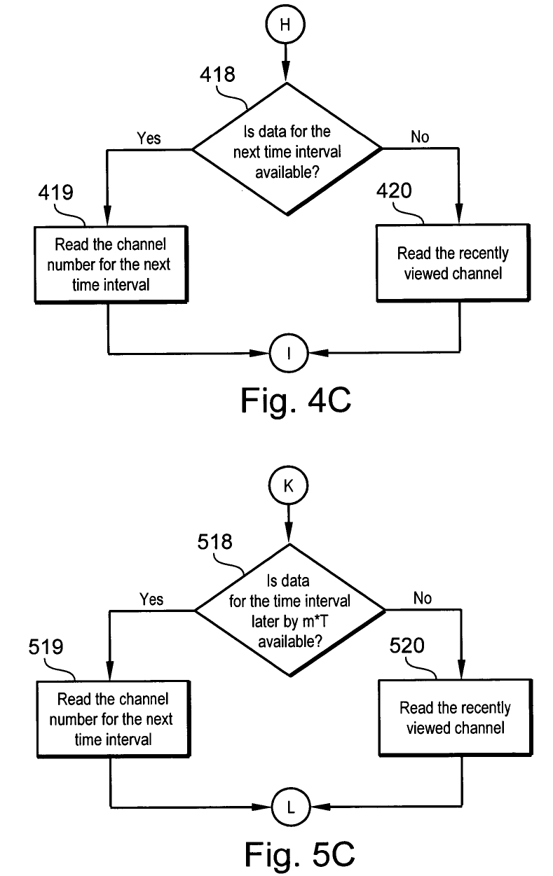

The algorithm for setting a channel (using the viewing ratings table) when switching the television receiver on is presented in FIGS. 4A, 4B, and 4C. After switching the receiver on in step 401, the system determines, in step 402, what mode the receiver is working in—the mode of setting the last viewed channel, or the most often viewed one. If the receiver is working in the mode of setting the last channel, the system checks whether there is an entry in the table for the current time interval from previous days—i.e. backtracks through the table day after day until it locates a filled field—step 403. If a filled field is located in step 403, the last viewed channel is set for the given time interval in step 404. If one is not located, the system goes on to check, in step 405, if a filled field exists in the table for the next time interval. If it does exist, the channel last viewed in the next time interval is set in step 406. If it does not exist, the channel viewed immediately prior to the last switching the television receiver off is set in step 407. The receiver then is set to the desired channel in step 408. If the receiver is working in the most often viewed channel mode, the first step is to check, in step 409, whether there is any data available for the current time interval from previous days. If yes, it checks in step 410 if there is any data available for the next time interval from previous days. If such data is available, the viewing rating of the favorite channel from the current time interval is compared to the one in the next time interval in steps 412, 413, and 414. The channel with the highest viewing ratings is set for the current time interval (K1) in step 415, and for the next one (K2) in step 416. If data for the next time interval is unavailable, the most often viewed channel from the current time interval is set in step 411. In case when data from the current time interval is unavailable, step 418 checks whether data for the next time interval is available. If yes, the most often viewed channel from the next time interval is set in step 419. If not, the channel viewed immediately prior to the last switching off of the television receiver is set—in step 420. The television receiver is set on the selected channel in step 417. The method for defining the most often viewed channel in a given time interval goes as follows: the system draws the values from individual rows in a given column and sets the channel most often viewed. If there is a tie for the most often viewed position, the one most recently viewed is set.

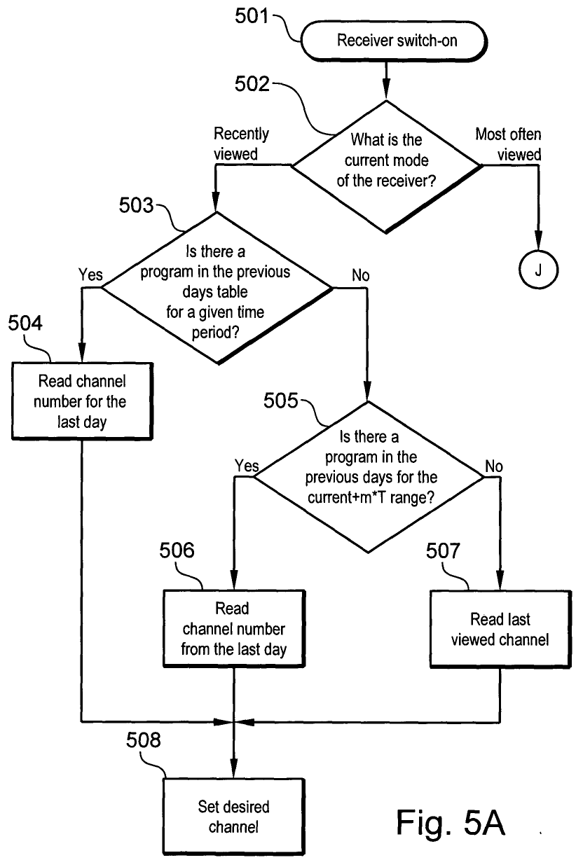

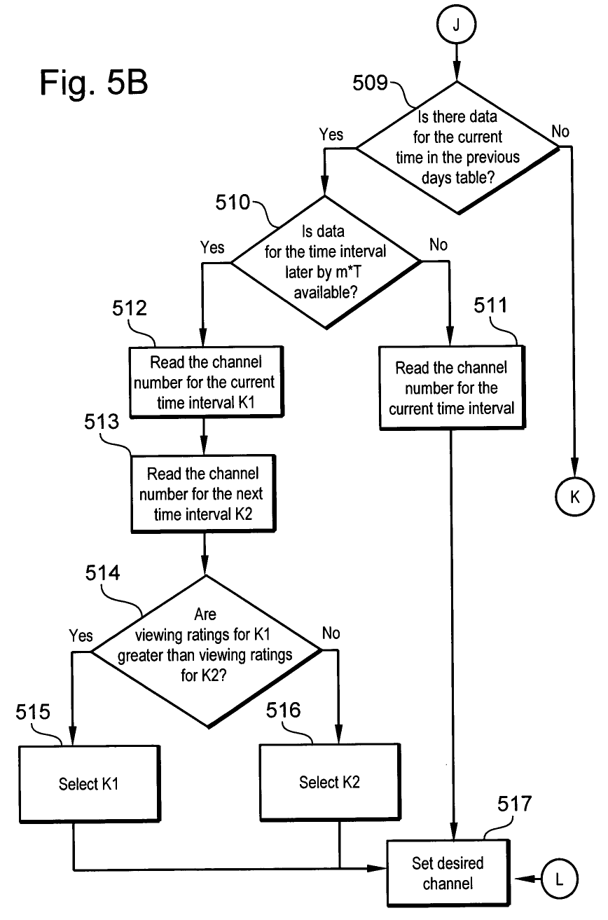

The algorithm for setting a channel (using the viewing ratings list) when switching the television receiver on is presented in FIGS. 5A, 5B, and 5C. When setting a channel the system searches through a list for a channel viewed on a given day at a given time. The time searched for may be the current time, or the current time+T. The previous days are checked consecutively. In order to define the date of the day to be considered “previous”, the following criteria are employed:

when setting the “each day of the week separate” option: the previous day is defined by subtracting seven days from the current day.

when setting the “all days together” option: the previous day is defined by subtracting one day from the current day.

when setting the “weekdays together, Saturdays separate, and Sundays separate” option: the method the previous day is defined depends on the day of the week. If it is Monday, Tuesday, Wednesday, Thursday, or Friday, the search goes back just as in the “all days together” option, but skipping Saturdays and Sundays. If it is a Saturday or a Sunday the search is conducted just as in the “each day of the week separate” option

when setting the “weekdays together and weekends together” option: the way a previous day is defined depends on the current day of the week. If it is Monday, Tuesday, Wednesday, Thursday, or Friday the search goes back just as in the “all days together” option, but skipping Saturdays and Sundays. If it is a Saturday or a Sunday the search is conducted just as in the “all days together” option, but skipping Monday, Tuesday, Wednesday, Thursday, and Friday.

The procedure begins in step 501 at the moment of switching the television receiver on. In step 502, it determines what mode the system is working in. If it is the setting the last channel viewed mode, it checks—in step 503—whether there were any channels viewed in the current time interval in the previous days. It accomplishes this by backtracking through the list, consecutively passing increasingly older days. If a channel viewed in that time interval is located, its number is read in step 504. If such a channel is not located, it checks—in step 505—whether in the previous days a channel was viewed at a time later than the current, for example at a time defined by the formula “current time+m*T”, where “m” is a coefficient defined in the system options. The larger the value of “m”, the higher the probability of finding some channel, but at the same time the lower the probability it will be a channel desired by the user. Backtracking increasingly far down the list, the system checks if there is a channel to be found between the current time and a time increased by m*T. If there is, its number is read in step 506. If one is not found, in step 507 the number of the last channel viewed—just prior to switching off the television receiver—is read. The desired channel is set in step 508. If the system is working in the most often viewed channel mode, the first step—509—is to check if there is any data available concerning the current time for previous days. If there indeed is, step 510 checks whether there is data also available for previous days for a time later than the current by m*T. If it is available as well, the viewing ratings of the favorite channel at the current time are compared with the viewing ratings of that at the later time in steps 512, 513, and 514. The channel with the highest viewing ratings at the current time (K1) is next set in step 515. The same is done for the later time (K2) in step 516. If there is no data available for the later time, the channel with the highest viewing ratings at the current time is set in step 511. In case where no data concerning the current time is available, the system checks, in step 518, if any data is available for a time later by m*T. If there is, the most often viewed channel from the later time is set in step 519. If there is no data, the last channel viewed prior to the television receiver being switched off is set in step 520. The television receiver is set to that set channel in step 517.

An example of the functioning of a system employing a table is shown below. The example includes a single table describing all the days of the week. It is made up of 4 rows, meaning it stores viewing ratings data for the last 4 days. The time interval T equals 10 minutes. The table shown here is for the times between the hours 18 and 22 (6:00 PM, and 10:00 PM).

| 1 | | | | | | 1 | | | | | | 2 | | | | | | 2 | | | | | |
|---|---|---|---|---|---|---|---|---|---|---|---|---|---|---|---|---|---|---|---|---|---|---|---|
| 8 | | | | | | 9 | | | | | | 0 | | | | | | 1 | | | | | |
| | | 5 | 5 | 5 | 5 | 5 | 5 | 7 | 7 | 7 | 7 | 7 | 7 | 7 | 8 | 8 | 8 | 8 | 8 | 8 | 8 | | |
| | | | | 7 | 7 | 7 | 7 | 7 | 7 | 7 | 7 | 7 | 7 | 7 | 7 | 7 | 7 | 7 | 5 | 5 | 5 | 5 | 5 |
| | | | | | | 7 | 7 | 5 | 5 | 5 | 5 | 5 | 5 | 5 | 5 | 5 | 5 | 5 | 5 | 5 | 5 | 5 | 5 |
| 8 | 8 | 8 | 5 | 5 | 5 | 5 | 5 | 5 | 5 | 5 | 5 | 7 | 7 | 7 | 7 | 7 | 7 | 7 | 7 | 7 | 7 | 7 | 7 |

Today, in between 18:20 and 19:20 (6:20 PM-7:20 PM) the user viewed channel 5. In between 19:20 and 20:30 (7:20 PM-8:30 PM) he viewed channel 7, and in between 20:30 and 21:40 (8:30 PM-9:40 PM)—channel 8. Yesterday from 18:40 to 21:10 (6:40 PM-10:10 PM) he viewed channel 7, and from 21:10 to 22:00 (10:10 PM-11:00 PM)—channel 5. Two days ago, from 19:00 to 19:20 (7:00 PM-7:20 PM)—channel 7, and from 19:20 to 22:00 (7:20 PM-10:00 PM)—channel 5. Three days ago, from 18:00 to 18:30 (6:00 PM-6:30 PM) he viewed channel 8, from 18:30 to 19:50 (6:30 PM-7:50 PM)—channel 5, and from 19:50 to 22:00 (7:50 PM-10:00 PM)—channel 7. When the user switches on his television receiver tomorrow, let us say at 19:00 (7:00 PM), the table will look as follows:

| 1 | | | | | | 1 | | | | | | 2 | | | | | | 2 | | | | | |
|---|---|---|---|---|---|---|---|---|---|---|---|---|---|---|---|---|---|---|---|---|---|---|---|
| 8 | | | | | | 9 | | | | | | 0 | | | | | | 1 | | | | | |
| | | 5 | 5 | 5 | 5 | 5 | 5 | 7 | 7 | 7 | 7 | 7 | 7 | 7 | 8 | 8 | 8 | 8 | 8 | 8 | 8 | | |
| | | | | 7 | 7 | 7 | 7 | 7 | 7 | 7 | 7 | 7 | 7 | 7 | 7 | 7 | 7 | 7 | 5 | 5 | 5 | 5 | 5 |
| | | | | | | 7 | 7 | 5 | 5 | 5 | 5 | 5 | 5 | 5 | 5 | 5 | 5 | 5 | 5 | 5 | 5 | 5 | 5 |
| 8 | 8 | 8 | 5 | 5 | 5 | 5 | 5 | 5 | 5 | 5 | 5 | 7 | 7 | 7 | 7 | 7 | 7 | 7 | 7 | 7 | 7 | 7 | 7 |

If the television receiver is set to the mode of setting the last channel viewed, channel 5 will be set. If, however, it is set to the mode of setting the channel most often viewed, the channel set will be 7. During the time of further viewing of the channel, the upper row of the table will be gradually filled with the numbers of channels viewed by the user. Referring to the above example, if the system was making use of a single viewing ratings list—storing the dates and times—it would look just as shown below, supposing it was Jun. 20, 2002.

| Channel | Start | Stop |
|---|---|---|
| 8 | 2002.06.20 20.35 | 2002.06.20 21.40 |
| 7 | 2002.06.20 19.22 | 2002.06.20 20.30 |
| 5 | 2002.06.20 18.23 | 2002.06.20 19.17 |
| 5 | 2002.06.19 21.10 | 2002.06.19 22.00 |
| 7 | 2002.06.19 18.40 | 2002.06.19 21.10 |
| 5 | 2002.06.18 19.20 | 2002.06.18 22.00 |
| 7 | 2002.06.18 19.00 | 2002.06.18 19.20 |
| 7 | 2002.06.17 20.05 | 2002.06.17 22.00 |
| 5 | 2002.06.17 18.33 | 2002.06.17 20.00 |
| 8 | 2002.06.17 18.02 | 2002.06.17 18.28 |

As it can be seen, the exact times for the beginnings and the endings of particular channels are stored on the list. In case the system was utilizing multiple viewing ratings lists, they would look as shown below. If the user was to switch his television receiver on at, let us say 19:00 (7:00 PM), the list would appear as follows:

| | | |
|---|---|---|
| Channel | Start | Stop |

2002.06.20 (Jun. 20, 2002)

| | | |
|---|---|---|
| 8 | 20.35 | 21.40 |
| 7 | 19.22 | 20.30 |
| 5 | 18.23 | 19.17 |

2002.06.19 (Jun. 19, 2002)

| | | |
|---|---|---|
| 5 | 21.10 | 22.00 |
| 7 | 18.40 | 21.10 |

2002.06.18 (Jun. 18, 2002)

| | | |
|---|---|---|
| 5 | 19.20 | 22.00 |
| 7 | 19.00 | 19.20 |

2002.06.17 (Jun. 17, 2002)

| | | |
|---|---|---|
| 7 | 20.05 | 22.00 |
| 5 | 18.33 | 20.00 |
| 8 | 18.02 | 18.28 |

Suppose the user switches his television receiver on the next day, also at 19:00 (7:00 PM). If the system is making use of a single list—and there is still space on that list for storing more records—the appearance of that list will be unaltered. If the system is utilizing several lists, and determines that there is no space for establishing a new list, the list from 2002.06.17 (Jun. 17, 2002) will be deleted and the data contained therein will be copied to the list from 2002.06.18 (Jun. 18, 2002), which will then assume the following appearance:

2002.06.18 (Jun. 18, 2002)

| | | |
|---|---|---|
| 5 | 19.20 | 22.00 |
| 7 | 19.00 | 19.20 |
| 5 | 18.33 | 19.00 |
| 8 | 18.02 | 18.28 |

The advantage of the presented solution lies in the channel setting procedure being initiated while switching the television receiver on. This means that upon depressing the “Power-on” button the user's “given time favorite” channel is automatically switched on. The channel viewing ratings is stored in a table or a list, the data contained therein is updated with the frequency defined by the time interval defining the accuracy of collected data, and therefore the accuracy with which the receiver will set the channel. The value of this time interval is optimal at T=10 min.

The solution described here stores the channels viewed by the user. It is common for the user to view the same favorite channels on a given day at a given time. The system keeps individual channel viewing ratings statistics, allowing to determine what channel was viewed most recently, or most often at a given time. The system is not hampered by quick changing of channel settings. Such activity is filtered out and the database created only contains channels viewed for longer than the length of a specified time interval. The statistics thus amassed are utilized while switching-on the television receiver. The disclosed method of setting the channel while switching the television receiver on may be employed with any television signal receiver that contains memory and a processor servicing the appropriate application. A typical device fulfilling these requirements is a digital television decoder, comprising a processor and sufficient memory.

The preferred embodiments having been thus described, it will now be evident to those skilled in the art that further variation thereto may be contemplated. Such variations are not to be regarded as a departure from the invention, the true scope of the invention being set forth in the claims appended hereto.

What is claimed is:

1. A device for selecting a channel of radio and television sets comprising
a central processing unit;
a signal receiving block linked to and controlled by the central processing unit and used to receive a signal and if necessary converting the signal to a digital format;
an A/V block linked to and controlled by the central processing unit and generating the signal to be displayed on a screen in a required format;
a memory block linked to and controlled by the central processing unit and containing various types of memory;
a viewing ratings analyzer controlled by the central processing unit and analyzing a viewing rating table and/or a viewing rating list stored in databases of a ratings storage block; and
a power-on block linked to and controlled by the viewing ratings analyzer for switching-on a set and setting a channel.

2. A method for selecting a channel of radio and television sets comprising
switching a set on;
monitoring channels viewed by a user;
storing data about channel viewing ratings in databases; and
searching the databases for information about channels viewed last or most often on a day of the week and at a time of switching the set on;
selecting a channel viewed last or most often on the day of the week and at the time of switching the set on; and
setting the channel viewed last or viewed most often on the day of the week and at the time of switching the set on.

3. The method for selecting the channel according to claim 2 wherein
one of the databases is a list having records comprising a number of a viewed channel, a viewing start time and a viewing stop time of the viewed channel.

4. The method for selecting the channel according to claim 3 wherein
the viewing ratings statistics is created for each day of the week separately or separately for workdays and separately for weekends or separately for workdays and individually for Saturdays and for Sundays.

5. The method for selecting the channel according to claim 3 wherein
the list is formed as a circular buffer, where time is stated as a date and an hour.

6. The method for selecting the channel according to claim 3 wherein
the list is formed as separate lists for each day, containing an unlimited number of records, where time is stated as an hour alone.

7. The method for selecting the channel according to claim 2 wherein
one of the databases is a table having columns defining time intervals, rows defining days and fields with a number of a viewed channel.

8. The method for selecting the channel according to claim 7 further comprising
copying the oldest data to free space of a row of the table before a last row of the table and deleting the last row of the table when there is insufficient space for new data.

9. The method for selecting the channel according to claim 2 further comprising
searching the databases for information about channels last viewed at a later time as compared to the time of switching the set on when the databases contain no data on channel viewing ratings on the day of the week and at the time of switching the set on;
selecting a channel last viewed at the later time as compared to the time of switching the set on when the databases contain no data on channel viewing ratings on the day of the week and at the time of switching the set on;
setting the channel last viewed at the later time.

10. The method for selecting the channel according to claim 2 further comprising
searching the databases for information about channels viewed at the time of switching the set on and at a later time;
comparing the viewing ratings of the channel viewed at the time of switching the set on and at the later time and selecting the channel with higher viewing ratings;
setting the channel with higher viewing ratings.

11. The method for selecting the channel according to claim 2 further comprising
setting a channel last viewed when no database was found.

12. The method for selecting the channel according to claim 2 wherein the searching is activated by a user by switching the set on by means of a “Power-on” button.
